(19) United States
(12) Patent Application Publication
(10) Pub. No.: US 2026/0342022 A1
(43) Pub. Date: Oct. 29, 2026

(54) HEIGHTENED GROUND INTERFACE

(71) Applicant: Molex, LLC, Lisle, IL (US)

(72) Inventors: John C. Laurx, Aurora, IL (US); Khang Choong Yong, Selangor (MY); Jose J. Gonzalez, JR., Joliet, IL (US)

(21) Appl. No.: 19/550,334

(22) Filed: Feb. 26, 2026

Related U.S. Application Data
(60) Provisional application No. 63/793,676, filed on Apr. 24, 2025.

(51) Int. Cl. H01R 13/6597; H01R 12/73

(52) U.S. Cl. CPC H01R 13/6597; H01R 12/73

(57) ABSTRACT

Connectors having ground and signal terminal conductors with contact tip surfaces positioned in different planes are described herein. An example connector includes a housing with a slot for insertion of a card edge interface and a row of terminal conductors positioned within the housing. The row of terminal conductors includes ground terminal conductors and signal terminal conductors. Contact tip surfaces of the ground terminal conductors are positioned in a different plane than contact tip surfaces of the signal terminal conductors. Card edge interfaces for use in a connector are also described herein. An example card edge interface includes a substrate and a row of terminal contacts on the substrate. The row of terminal contacts includes ground pad contacts and signal pad contacts. Contact pad surfaces for the ground pad contacts are positioned in a different plane than contact pad surfaces for the signal pad contacts.

### BACKGROUND

The amount of data processed by computers, computing systems, and computing environments continues to increase. Data centers, for example, can include hundreds of computing and networking systems interconnected using optical cables, copper cables, and a wide range of different connectors, cable assemblies, and terminations between them. The data throughput of these interconnect systems is high and increasing. As examples, many data centers incorporate a combination of 10 Gigabit Ethernet (10GbE), 25 GbE, 50 GbE, and 100 GbE network interfaces and interconnects. 200 GbE, 400 GbE, and 800 GbE interconnection technologies are also being developed and deployed. Other interconnection solutions rely upon 56 Gigabit per second (Gb/s), 112 Gb/s, and 224 Gb/s interconnection technologies, and interconnection technologies are being developed to support higher data rates. A range of cable assemblies and connectors are available for the data interconnects. A variety of different designs exist for the cable assemblies and connectors.

It can be particularly challenging to design connectors for high data rate applications and interconnection systems due to a number of competing concerns. High data rate interconnection systems often rely upon differentially coupled signal pairs in which two conductors are arranged in a pair to transmit a differential signal. The signal being transmitted is embodied by the electrical voltage/current difference measured between the two conductors. Differential signaling can be helpful to avoid or reject spurious signals and crosstalk and to avoid inadvertent signaling modes among adjacent signal pairs. In connector interfaces, ground terminals can be relied upon to create a current return path to electrical ground, provide shielding between differential pairs, and for other purposes.

Connectors used in high data rate applications are typically designed to meet a range of mechanical and electrical requirements. High data rate connectors are often used in backplane applications, as one example, that require very high conductor density and data rates. To achieve the desired mechanical and electrical requirements, the connectors used in such applications often incorporate one or more wafer assemblies. The wafer assemblies can include an insulative web that supports the signal and ground terminal conductors in the wafer assemblies. The use of wafer assemblies can be helpful to manufacture connectors capable of achieving high data rates using a number of different assembly processes. It is still challenging, in any case, to design connectors having the size and conductor density needed for new systems, while also maintaining the electrical characteristics needed for the data rates and signal integrity specified by emerging industry standards and customer specifications.

### SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures. Various aspects and embodiments of connectors having ground and signal terminal conductors with contact tip surfaces positioned in different planes are described herein. An example connector includes a housing with a slot for insertion of a card edge interface and a row of terminal conductors positioned within the housing. The row of terminal conductors includes ground terminal conductors and signal terminal conductors. Contact tip surfaces of the ground terminal conductors are positioned in a different plane than contact tip surfaces of the signal terminal conductors.

The contact tip surfaces of the signal terminal conductors can be positioned in a first plane in many examples and the contact tip surfaces of the ground terminal conductors can be positioned in a second plane that is offset from a longitudinal centerline of the slot of the housing relative to the first plane.

In other aspects, the contact tip surfaces of the signal terminal conductors can be configured to contact signal contact pads on the card edge interface in a first contact plane when the card edge interface is inserted into the slot of the housing and the contact tip surfaces of the ground terminal conductors can be configured to contact a ground shield on the card edge interface in a second contact plane when the card edge interface is inserted into the slot of the housing. The second contact plane can be offset from the longitudinal centerline of the slot of the housing relative to the first contact plane in many cases.

In still other aspects, the ground terminal conductors can include first bends that position the contact tip surfaces of the ground terminal conductors away from a longitudinal centerline of the slot of the housing. The ground terminal conductors can also include second bends that position the contact tip surfaces of the ground terminal conductors toward the longitudinal centerline of the slot of the housing. The first bends and the second bends can collectively position the contact tip surfaces of the ground terminal conductors at a different distance from the longitudinal centerline of the slot relative to the contact tip surfaces of the signal terminal conductors in many examples.

The first bends can be located farther from the contact tip surfaces of the ground terminal conductors relative to the second bends in many cases. In some cases, the first bends have a bend angle that is equal to a bend angle of the second bends relative to the longitudinal centerline of the slot of the housing. In other examples, the first bends have a bend angle that is less than a bend angle of the second bends relative to the longitudinal centerline of the slot of the housing. In still other examples, the first bends have a bend angle that is greater than a bend angle of the second bends relative to the longitudinal centerline of the slot of the housing.

In many aspects, the first bends project first segments of the ground terminal conductors away from the longitudinal centerline of the slot and the second bends project second segments of the ground terminal conductors toward the longitudinal centerline of the slot of the housing. The signal terminal conductors can also include bends that project segments of the signal terminal conductors toward the longitudinal centerline of the slot of the housing in many cases. The segments of the signal terminal conductors can be parallel to and offset from the second segments of the ground terminal conductors relative to the longitudinal centerline of the slot housing in many examples.

Various aspects and embodiments of card edge interfaces having ground and signal pad contacts with contact pad surfaces positioned in different planes are also described herein. An example card edge interface for use in a connector includes a substrate and a row of terminal contacts on the substrate. The row of terminal contacts includes ground pad contacts and signal pad contacts. Contact pad surfaces for the signal pad contacts of the card edge interface are positioned in a first contact plane and contact pad surfaces for the ground pad contacts are positioned in a second contact plane.

In many aspects, the card edge interface can further include a ground shield on at least a subset of the ground pad contacts. The ground shield can include a ground terminal ramp at one side in many cases. The ground terminal ramp can extend at an inclined angle relative to the first contact plane. An upper surface of the ground shield can include the contact pad surfaces for the ground pad contacts in many cases. The ground shield can include a plurality of U-shaped shield pockets in some examples. The ground shield in some cases can include at least one of copper, a copper alloy, aluminum, or an aluminum alloy. In many examples, the ground shield can be coupled to at least a subset of the ground pad contacts using a conductive adhesive or solder.

In still other aspects, the ground shield can include a riser shield that extends a distance over at least a subset of the ground pad contacts. The distance can be set based on a lateral distance between a ground pad contact among the ground pad contacts and a signal pad contact among the signal pad contacts in some examples. The distance can be at least three times greater than the lateral distance in one example. In another example, the distance can be up to five times greater than the lateral distance.

In other aspects, the ground pad contacts can be formed on a first layer of the substate and the signal pad contacts can be formed on a second layer of the substate different from the first layer of the substate. In still other aspects, the substrate can include a plurality of layers. The ground pad contacts can be formed on a first layer of the substate in one example. The signal pad contacts can be formed on a second layer of the substate different from the first layer of the substate in this example. The substrate can include at least one additional layer between the first layer and the second layer in some examples.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a top-down perspective view of an example connector according to various embodiments of the present disclosure.

FIG. 1B illustrates a bottom-up perspective view of the connector shown in FIG. 1A according to various embodiments of the present disclosure.

FIG. 1C illustrates a perspective view of the connector shown in FIG. 1A, mounted to an example printed circuit board and mated with an example board card edge interface according to various embodiments of the present disclosure.

FIG. 1D illustrates a cross-sectional side view of the connector shown in FIG. 1A, mounted to an example printed circuit board and mated with an example board card edge interface according to various embodiments of the present disclosure.

FIG. 2A illustrates example wafer assemblies of the connector shown in FIG. 1A, with a housing of the connector omitted from view according to various embodiments of the present disclosure.

FIG. 2B illustrates an example wafer assembly of the connector shown in FIG. 1A, with parts expanded apart, according to various embodiments of the present disclosure.

FIG. 2C illustrates another example wafer assembly of the connector shown in FIG. 1A, with parts expanded apart, according to various embodiments of the present disclosure.

FIG. 3A illustrates a top-down perspective view of an example board card edge interface according to various embodiments of the present disclosure.

FIG. 3B illustrates another top-down perspective view of the board card edge interface shown in FIG. 3A with certain components removed from view according to various embodiments of the present disclosure.

FIG. 3C illustrates a side view of the board card edge interface shown in FIG. 3A according to various embodiments of the present disclosure.

FIG. 3D illustrates a front view of the board card edge interface shown in FIG. 3A according to various embodiments of the present disclosure.

FIG. 3E illustrates another front view of the board card edge interface shown in FIG. 3A with certain components removed from view according to various embodiments of the present disclosure.

FIG. 4A illustrates a side view of the board card edge interface and terminals in the connector shown in FIG. 1C according to various embodiments of the present disclosure.

FIG. 4B illustrates another side view of the board card edge interface and terminals in the connector shown in FIG. 1C with certain components on the board card edge interface removed from view according to various embodiments of the present disclosure.

FIG. 4C illustrates a side view of example rows of terminal conductors in the connector shown in FIG. 1A according to various embodiments of the present disclosure.

FIG. 5 illustrates a front view of an example substrate of the board card edge interface shown in FIG. 3A according to various aspects and embodiments of the present disclosure.

### DETAILED DESCRIPTION

The amount of data processed by computers, computing systems, and computing environments continues to increase. Data centers, for example, can include hundreds of computing and networking systems interconnected using optical cables, copper cables, and a wide range of different connectors, cable assemblies, and terminations between them.

The small form-factor pluggable (SFP) module format is a compact, hot-pluggable network interface module format used for data interconnects, and SFP modules are commonly used for interconnects in data centers. An SFP interface on a computing or networking system is a modular slot for a media-specific transceiver, such as a copper or fiber-optic cable assembly. Cable assemblies can include SFP transceiver modules at one or both ends of a copper, fiber-optic, or other type of interconnecting cable. SFP transceiver modules can be inserted into SFP interfaces for data interconnections.

A range of SFP transceiver modules are currently available, such as small form-factor pluggable double density (SFP-DD), compact small form-factor pluggable (cSFP), SFP+, quad small form-factor pluggable (QSFP), quad small form-factor pluggable double density (QSFP-DD), octal small form factor pluggable (OSFP), and others. An active electrical cable (AEC) assembly can include an SFP transceiver module at the free end of cables or a cable bundle. An AEC assembly can include one or more printed circuit boards (PCBs) and semiconductor chips for signal re-timing, noise reduction, signal integrity improvement, and other functions. SFP transceiver modules often include one or more PCBs with semiconductor circuit devices or chips and other circuitry mounted to the PCBs. The PCBs can provide PCB-style tip interfaces at one end or side of the module, for insertion into a mating connector.

Connectors are often designed to meet a range of different electrical and mechanical requirements or specifications. Many connectors incorporate one or more wafer assemblies that are carefully designed to meet or exceed industry standard or related specifications. The use of wafer assemblies can be helpful to manufacture connectors capable of high data rates using a range of different assembly processes. It is still challenging, in any case, to design connectors having the size and conductor density needed for new systems, while also maintaining the electrical characteristics needed for the data rates and signal integrity specified by emerging industry standards and customer specifications.

In the context outlined above, various aspects and embodiments of connectors having ground and signal terminal conductors with contact tip surfaces positioned in different planes are described herein. An example connector includes a housing with a slot for insertion of a card edge interface and a row of terminal conductors positioned within the housing. The row of terminal conductors includes ground terminal conductors and signal terminal conductors. Contact tip surfaces of the ground terminal conductors are positioned in a different plane than contact tip surfaces of the signal terminal conductors. The contact tip surfaces of the signal terminal conductors are configured to contact signal contact pads on the card edge interface in a first contact plane when the card edge interface is inserted into the slot of the housing, and the contact tip surfaces of the ground terminal conductors are configured to contact a ground shield on the card edge interface in a second contact plane when the card edge interface is inserted into the slot of the housing. The second contact plane is offset from a longitudinal centerline of the slot of the housing relative to the first contact plane.

Further in the context outlined above, various aspects and embodiments of card edge interfaces having ground and signal pad contacts with contact pad surfaces positioned in different planes are also described herein. An example card edge interface for use in a connector includes a substrate and a row of terminal contacts on the substrate. The row of terminal contacts include ground pad contacts and signal pad contacts. Contact pad surfaces for the signal pad contacts of the card edge interface are positioned in a first contact plane, and contact pad surfaces for the ground pad contacts are positioned in a second contact plane.

The ground and signal terminal conductors with contact tip surfaces positioned in different planes in the connectors described herein help to improve electromagnetic interference (EMI) shielding, control signal integrity performance, and allow for increased data rates through connectors. The ground and signal pad contacts having contact pad surfaces positioned in different contact planes on the card edge interfaces described herein also help to improve EMI shielding, control signal integrity performance, and allow for increased data rates through connectors such as those of the present disclosure.

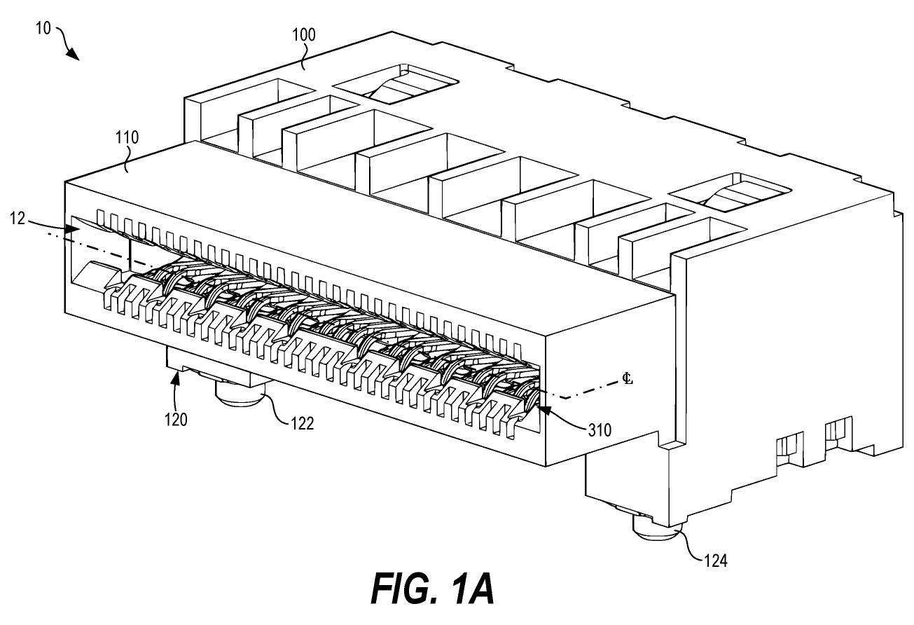

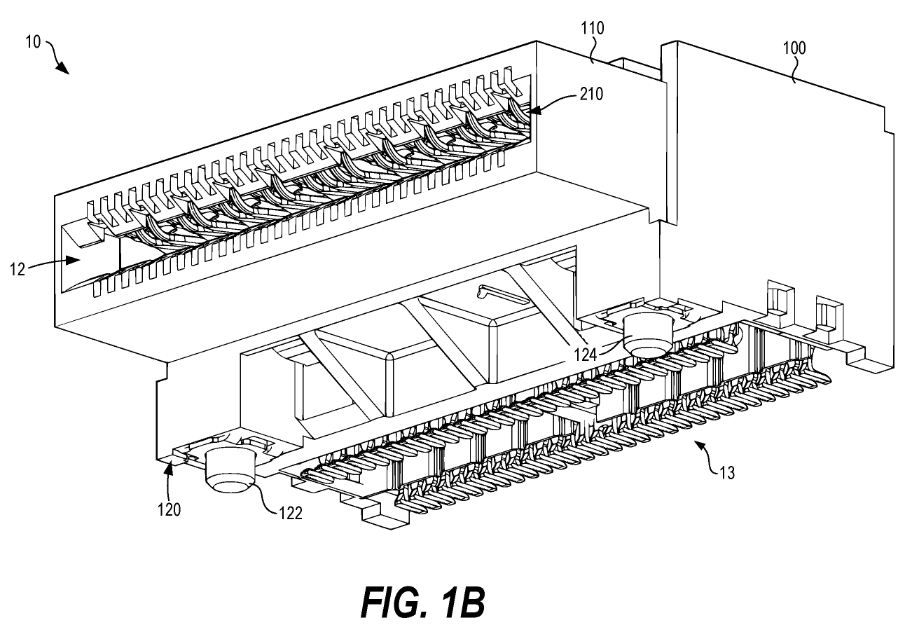

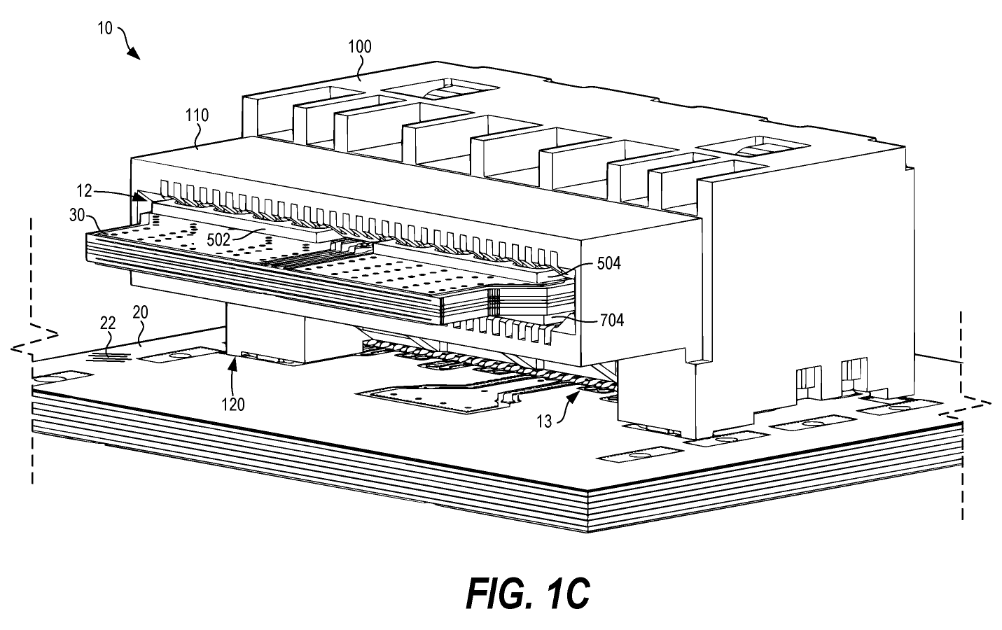

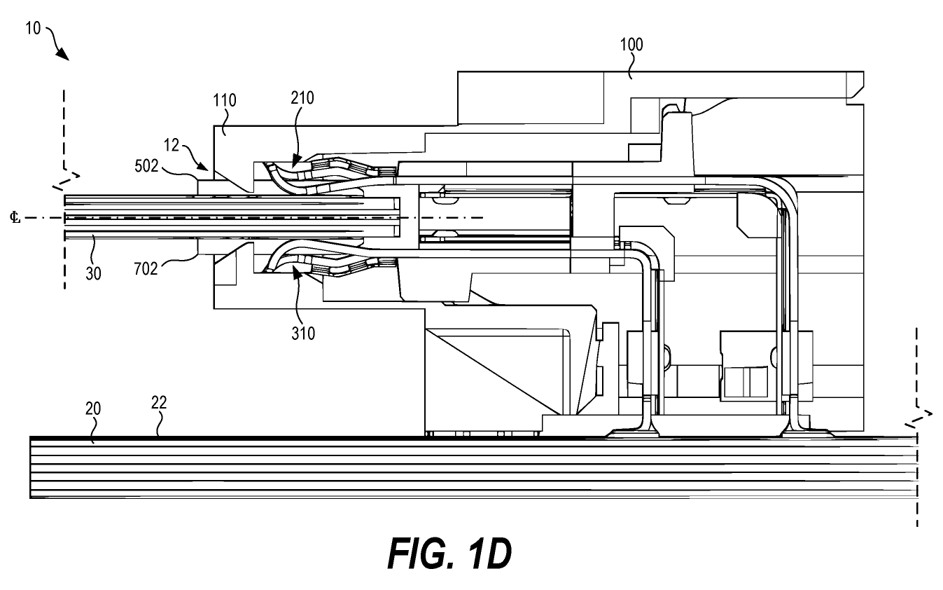

Turning to the drawings, FIG. 1A illustrates a top-down perspective view of an example connector 10 according to various embodiments of the present disclosure. FIG. 1B illustrates a bottom-up perspective view of the connector 10 according to various embodiments of the present disclosure. The connector 10 is illustrated as a representative example of a connector including ground and signal terminal conductors with contact tip surfaces positioned in different planes. The concepts described herein can be extended to use with a range of connectors of different types, styles, and formats, however. The connector 10 is not drawn to any particular scale or size in the drawings. The shape, size, proportion, and other characteristics of the connector 10 can vary as compared to that shown. For example, the connector 10 can accommodate larger or smaller rows of terminal conductors (e.g., be wider or narrower), and other variations are within the scope of the examples described herein. A number of connectors similar to the connector 10 can be stacked or arranged side-by-side, for higher data rate interconnection systems. Additionally, one or more of the parts or components of the connector 10, as illustrated in the drawings and described herein, can be omitted in some cases. The connector 10 can also include other parts or components that are not illustrated.

The connector 10 includes a front port opening 12 and a terminal foot 13 (see FIG. 1B). The connector 10 is designed to establish and maintain electrical connections with contact pads on opposing sides of a board card edge interface. As one example, the PCB-style tip of an SFP transceiver module can be inserted into the front port opening 12 of the connector 10. The connector 10 includes two (2) rows of signal terminal conductors and ground terminal conductors in the example shown. Other connectors incorporating the concepts described herein can include additional rows of signal and ground terminal conductors. The signal and ground terminal conductors are supported by wafer assemblies of the connector 10, as described in additional detail below. The signal and ground terminal conductors extend from the front port opening 12 to the terminal foot 13 of the connector 10, for the communication of data signals through the connector 10.

The connector 10 is designed to provide shielding and maintain the signal integrity of differential signals that are transmitted over the signal terminal conductors within the connector 10, as they extend from the front port opening 12 to the terminal foot 13. The connector 10 can be designed as a mating connector for use with SFP or related interconnection systems, as one example, although the connector 10 can be mated with other types of board card edge interconnection systems. The concepts described herein are also not limited to use with any particular type or style of interconnection system. The terminal foot 13 of the connector 10 can be designed as a surface mount technology (SMT) foot for coupling to the surface of a PCB, but the connector 10 can also be designed to have through-hole or other lead styles of terminal conductors at the terminal foot 13. The connector 10 is shown mounted to a PCB in FIG. 1C. The concepts described herein can also be extended to connectors that incorporate bypass cables, and certain signal and ground terminal conductors of the connector 10 can be directly coupled to one or more twinax cables in some cases, for signal bypass applications.

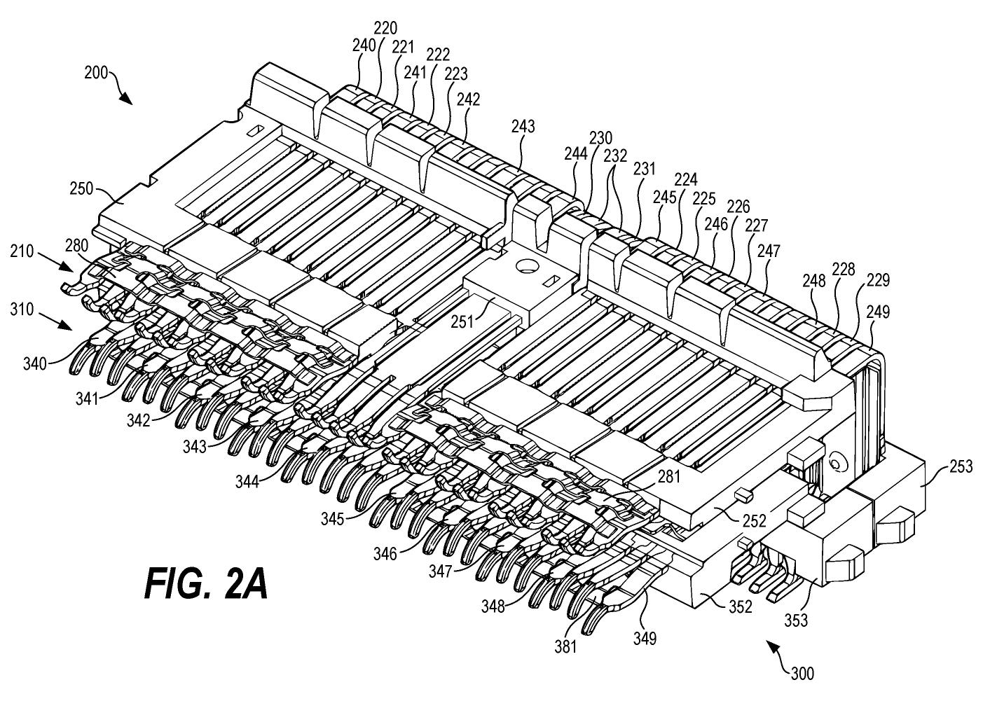

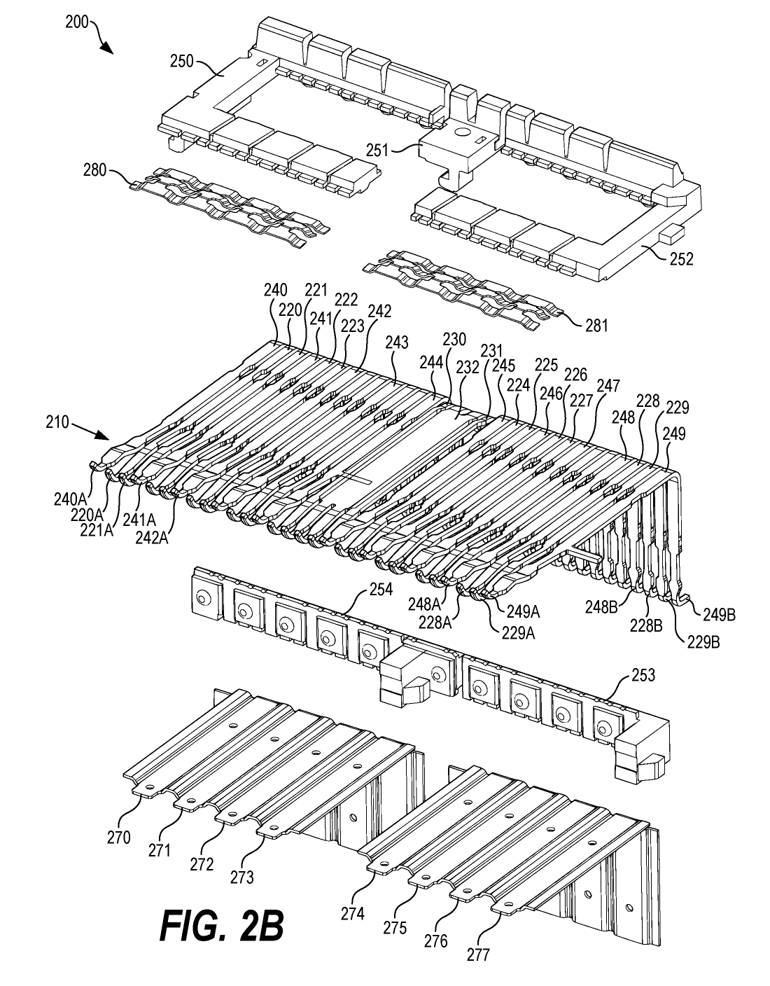

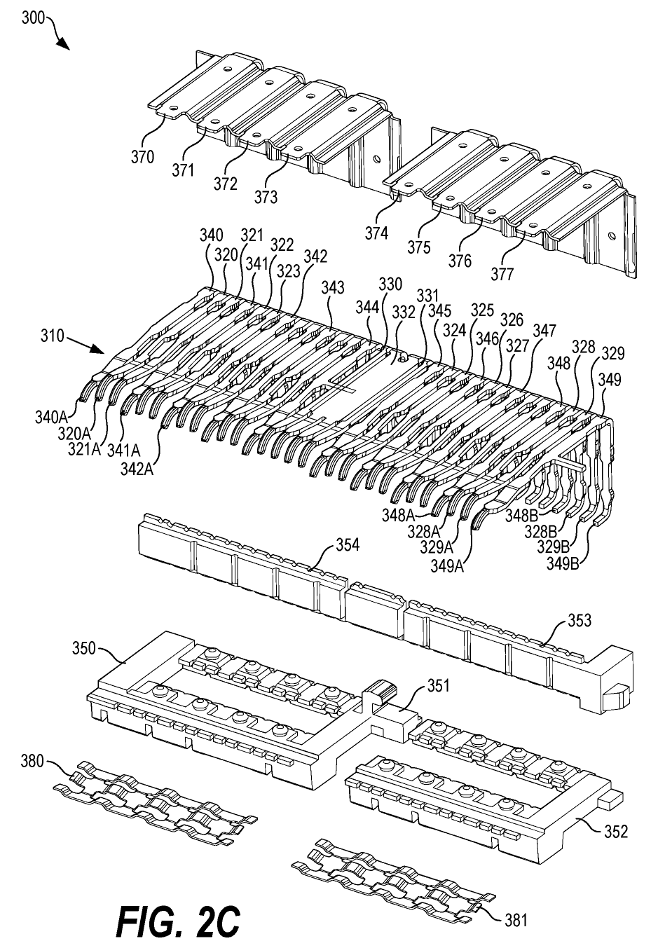

As shown in FIGS. 1A and 1B, the connector 10 includes a housing 100 and rows 210 and 310 of signal and ground terminal conductors having contact tips located at and within the opening 12. The connector 10 includes an upper wafer assembly that is positioned and secured within the housing 100 and a lower wafer assembly that is positioned and secured within the housing 100. The wafer assemblies are described in further detail below with reference to FIGS. 2A-2C. The row 210 is provided by the upper wafer assembly, and the row 310 is provided by the lower wafer assembly, as also described below.

The housing 100 can be formed from a plastic, polymer, or other insulating material, such as liquid crystal polymer (LCP), polyethylene (PE), polytetrafluoroethylene (PTFE), fluoropolymer, or other plastic or insulating material(s). The housing 100 can also be formed from metal or combinations of insulating and conductive materials in some cases. The housing 100 can be formed using any suitable additive or subtractive manufacturing techniques, including molding, injection molding, printing, and other techniques.

The housing 100 includes a front port 110, a bottom mounting surface 120, and mounting posts 122 and 124, among other features. The connector 10 can be configured to receive the PCB-style tip of an SFP transceiver module, as one example, although the connector 10 can also receive other types of board card edge interfaces. When the PCB-style tip is inserted into the front port opening 12, the rows 210 and 310 of signal terminal conductors and ground terminal conductors will contact, wipe against, and make electrical contact with contact pads on the top and bottom surfaces of the PCB-style tip.

The shielding for the signal terminal conductors in the rows 210 and 310 can be particularly important for the connector 10. Suitable EMI shielding can be necessary to meet the electrical characteristic and signal integrity specifications of emerging industry standards, as one example among other reasons. EMI shielding is important throughout the connector 10, including within the front port opening 12, at the terminal foot 13, and inside the body of the housing 100 between the opening 12 and the foot 13.

Each pair of signal terminal conductors in the rows 210 and 310 extends along and within a pair of ground terminal conductors, between the front port opening 12 and the terminal foot 13 of the connector 10. Contact tip surfaces of the signal terminal conductors in the rows 210 and 310 are positioned in a different plane than contact tip surfaces of the ground terminal conductors as described in further detail herein.

FIG. 1C illustrates a perspective view of the connector 10 shown in FIGS. 1A and 1B, mounted to a PCB 20 and mated with a board card edge interface 30 (also “card edge interface 30”). FIG. 1D illustrates a cross-sectional side view of the connector 10 shown in FIGS. 1A and 1B, mounted to the PCB 20 and mated with the board card edge interface 30. The bottom mounting surface 120 of the connector 10 is seated upon a top surface 22 of the PCB 20. Although not visible in FIG. 1C, the mounting posts 122 and 124 of the connector 10 are inserted into apertures through the PCB 20, which helps to secure the connector 10 in place with respect to the PCB 20. The tail ends of the signal terminal conductors and the ground terminal conductors in the rows 210 and 310 can be electrically coupled to contact pads on the top surface of the PCB 20 using solder, conductive adhesives, welds, or other means at the terminal foot 13 of the connector 10. In that way, differential data signals, for example, transmitted on the signal terminal conductors of the connector 10 can be electrically coupled to the PCB 20 and traces extending on and through the PCB 20.

Contact tip surfaces of the signal terminal conductors in the rows 210 and 310 are positioned in a first plane and contact tip surfaces of the ground terminal conductors are positioned in a second plane that is offset from a longitudinal centerline (℄) (see FIGS. 1A and 1D) of the opening 12 relative to the first plane. The ground terminal conductors in the rows 210 and 310 include first bends that position contact tip surfaces of the ground terminal conductors away from the longitudinal centerline ℄ of the opening 12. The ground terminal conductors in the rows 210 and 310 also include second bends that position the contact tip surfaces of the ground terminal conductors toward the longitudinal centerline ℄ of the opening 12. The first and second bends in the ground terminal conductors collectively position the contact tip surfaces of the ground terminal conductors at a different distance from the longitudinal centerline ℄ of the opening 12 relative to the contact tip surfaces of the signal terminal conductors in the rows 210 and 310.

The first bends in the ground terminal conductors are located farther from the contact tip surfaces of the ground terminal conductors relative to the second bends. In some cases, the first bends have a bend angle that is equal to a bend angle of the second bends relative to the longitudinal centerline ℄ of the opening 12. In other examples, the first bends have a bend angle that is less than a bend angle of the second bends relative to the longitudinal centerline ℄ of the opening 12. In still other examples, the first bends have a bend angle that is greater than a bend angle of the second bends relative to the longitudinal centerline ℄ of the opening 12.

The first bends in the ground terminal conductors project first segments of the ground terminal conductors away from the longitudinal centerline ℄ of the opening 12, and the second bends project second segments of the ground terminal conductors toward the longitudinal centerline ℄ of the opening 12. The signal terminal conductors in the rows 210 and 310 include bends that project segments of the signal terminal conductors toward the longitudinal centerline ℄ of the opening 12. The segments of the signal terminal conductors may be approximately parallel to and offset from the second segments of the ground terminal conductors relative to the longitudinal centerline ℄ of the opening 12 in some cases. In other examples, such segments of the signal terminal conductors may not be parallel to the second segments of the ground terminal conductors relative to the longitudinal centerline ℄ of the opening 12. In some cases, the bend angle of the second bends in the ground terminal conductors may be different from the bend angle of the bends in the signal terminal conductors relative to the longitudinal centerline ℄ of the opening 12.

FIG. 1C also illustrates the board card edge interface 30 inserted into the front port opening 12 of the connector 10. The board card edge interface 30 is representative of a PCB-style tip of an SFP module, although other types of board card edge interfaces can be inserted into the front port opening 12. The board card edge interface 30 includes ground and signal pad contacts with contact pad surfaces positioned in different planes. The board card edge interface 30 includes a substrate and rows of terminal contacts on the substrate in at least one example. The rows of terminal contacts include signal pad contacts and ground pad contacts. Contact pad surfaces for the signal pad contacts are positioned in a first contact plane and contact pad surfaces for the ground pad contacts are positioned in a second contact plane. The second contact plane is offset from the longitudinal centerline ℄ of the opening 12 relative to the first contact plane in this example.

As described further herein, the board card edge interface 30 may include ground shields on a least a subset of the ground pad contacts on the board card edge interface 30. The ground shields include a ground terminal ramp at one side. The ground terminal ramp extends at an inclined angle relative to the first contact plane where the contact pad surfaces for the signal pad contacts are positioned on the board card edge interface 30. The ground shields further include upper surfaces positioned in the second contact plane. The upper surfaces of the ground shields include and are embodied as the contact pad surfaces for the ground pad contacts on the board card edge interface 30 in this example, although another surface of the ground shields may be relied on in other cases.

The ground shields can be embodied as riser shields that extend a vertical distance over at least a subset of the signal pad contacts on the board card edge interface 30. The distance can be set based on a lateral distance between one of the ground pad contacts and one of the signal pad contacts on the board card edge interface 30 in some cases. The vertical distance can be at least three times greater than the lateral distance in one example and up to five times greater than the lateral distance in another example.

When the board card edge interface 30 is inserted into the front port opening 12, the rows 210 and 310 of signal and ground terminal conductors wipe against and make electrical contact with contact pads on top and bottom surfaces of the board card edge interface 30. As discussed above, the shielding for the signal terminal conductors in the rows 210 and 310 can be particularly important for the connector 10. EMI shielding is important throughout the connector 10, including within the front port opening 12, at the terminal foot 13, and inside the body of the housing 100 between the opening 12 and the foot 13.

To at least partly facilitate such EMI shielding, contact tip surfaces of signal terminal conductors in the connector 10 are configured to contact signal contact pads on the board card edge interface 30 in a first contact plane when the board card edge interface 30 is inserted into the opening 12 of the connector 10 and contact tip surfaces of ground terminal conductors in the connector 10 are configured to contact upper surfaces of ground or riser shields on the board card edge interface 30 in a second contact plane when the board card edge interface 30 is inserted into the opening 12. Pairs of the ground terminal conductors in the connector 10 and the ground shields on the board card edge interface 30 also substantially surround and provide sidewall shields for each pair of signal terminal conductors in the connector 10 when the board card edge interface 30 is inserted and fully seated into the front port opening 12 of the connector 10. The ground shields form EMI shield pockets over top and bottom surfaces of the board card edge interface 30. These and other aspects of the embodiments are described in further detail below.

FIG. 2A illustrates wafer assemblies 200 and 300 of the connector 10 shown in FIGS. 1A and 1B, with the housing 100 of the connector 10 omitted from view. FIG. 2B illustrates parts of the wafer assembly 200 expanded apart from each other, and FIG. 2C illustrates parts of the wafer assembly 300 expanded apart from each other. The wafer assembly 200 can be referred to as an upper wafer assembly in the connector 10, and the wafer assembly 300 can be referred to as a lower wafer assembly in the connector 10. The wafer assemblies 200 and 300 include signal terminal conductors (also “signal terminals”) for the communication of high-speed data signals, low-speed data signals, and power through the connector 10. The wafer assemblies 200 and 300 also include ground terminal conductors (also “ground terminals”). The signal terminal conductors of the wafer assembly 200 can transfer data from the front port opening 12 to the terminal foot 13 of the connector 10 (e.g., be used for data reception), and the signal terminal conductors in the wafer assembly 300 can transfer data from the terminal foot 13 to the front port opening 12 of the connector 10 (e.g., be used for data transmission). However, the wafer assemblies 200 and 300 and the pairs of signal terminal conductors in the wafer assemblies 200 and 300 are not limited to any particular direction of data transfer and can be used in any combination of data reception and transmission, between the front port opening 12 to the terminal foot 13 of the connector 10, among the embodiments.

Referring among FIGS. 2A and 2B, the wafer assembly 200 includes signal terminal conductors 220-229, 230, and 231 (also “signal terminals 220-229, 230, and 231”), among others, a power terminal conductor 232 (also “power terminal 232” and collectively “terminals 220-229 and 230-232”), ground terminal conductors 240-249 (also “ground terminals 240-249”), wafer molding inserts 250-254 (also “inserts 250-254”), rigid shields 270-277, and flexible shields 280 and 281. The wafer assembly 200 is illustrated as a representative example in FIG. 2A and 2B, and the size, number, shape, and other aspects of the components of the wafer assembly 200 can vary as compared to that shown.

The terminals 220-229 and 230-232 can be formed (e.g., stamped, sheared, bent, and otherwise formed) from a flat sheet of metal or other conductive material. In some cases, the sheet of metal can be plated with one or more plating metals. Each of the ground terminal conductors 240-249 can also be formed from the same flat sheet of metal or other conductive material, which can be plated in some cases.

The terminals 220-229 and 230-232 can be formed (e.g., stamped, sheared, bent, and otherwise formed) in a row, alongside each other, and at the same time from a single sheet of metal, in one example. Each of the terminals 220-229 and 230-232 includes a lead or tip contact at one distal end (i.e., positioned in the front port opening 12 of the connector 10, as shown in FIGS. 1B, 1D), a tail contact at another distal end (i.e., positioned at the terminal foot 13), and a terminal conductor body and bend between the tip contact and the tail contact. For example, as shown in FIG. 2B, the signal terminal conductor 228 includes a tip contact 228A and a tail contact 228B, and the signal terminal conductor 229 includes a tip contact 229A and a tail contact 229B. As also shown in FIG. 2B in this example, the ground terminal conductor 248 includes a tip contact 248A and a tail contact 248B, and the ground terminal conductor 249 includes a tip contact 249A and a tail contact 249B. The tail contacts of the terminals 220-229 and 230-232 and the ground terminal conductors 240-249 can be formed as SMT tail contacts, as in the example shown, or as through-hole (e.g., eye-of-needle) or other types of tail contacts.

The signal terminal conductors 220-229, among others in the wafer assembly 200, can be arranged and used in pairs of terminal conductors to transfer high-speed differential signals. For example, the conductors 220 and 221 can be relied upon as a first pair of signal terminal conductors for communicating a first high-speed differential signal, the conductors 222 and 223 can be relied upon as a second pair of signal terminal conductors for communicating a second high-speed differential signal, the conductors 224 and 225 can be relied upon as a third pair of signal terminal conductors for communicating a third high-speed differential signal, and so on. The signal terminal conductors 230 and 231, among possibly others in the wafer assembly 200, can be relied upon as a pair of signal terminal conductors for communicating a first low-speed differential signal. The power terminal conductor 232 can be relied upon to source or sink power, for example, such as for sinking or sourcing a direct current (DC) supply of power at 5V, 12V, or another potential.

The ground terminal conductors 240-249, the rigid shields 270-277, and the flexible shields 280 and 281 form part of a shielding and grounding network for the signal terminals in the wafer assembly 200 of the connector 10. The signal terminal conductors 220-229, 230, and 231, the power terminal conductor 232, the ground terminal conductors 240-249, and other terminal conductors of the wafer assembly 200 can be arranged with the rigid shields (e.g., 270-277 as shown in FIGS. 2A and 2B). The signal terminal conductors 220-229 extend along channels of the rigid shields 270-277 in the wafer assembly 200. As shown in FIG. 2B, the pair of signal terminal conductors 220 and 221 can be positioned to extend along the channel of the rigid shield 270. In that arrangement, the rigid shield 270 provides EMI shielding for the signal terminal conductors 220 and 221 and helps to reduce crosstalk and spurious signals between the signal terminal conductors 220 and 221 and other terminal conductors in the connector 10. Similarly, the pair of signal terminal conductors 222 and 223 can be positioned to extend within the channel of the rigid shield 271, the pair of signal terminal conductors 224 and 225 can be positioned to extend within the channel of the rigid shield 274, and so on. In some examples, the wafer assembly 200 can include an additional rigid shield (not illustrated) that can be positioned at the middle of the wafer assembly 200 between the rigid shields 273 and 274. The signal terminal conductors 230 and 231 and the power terminal conductor 232 can be positioned to extend along the channel of such an additional shield, which can be similar to the rigid shields 270-277 and wider in these examples to accommodate the terminal conductors 230-232.

The inserts 250-254 can be formed by injection molding. In one example, the terminal conductors 220-229 and 230-232, among others in the row 210, can be arranged and positioned in a mold along with the ground terminal conductors 240-249. The inserts 250-254 can then be formed by the injection of a plastic or polymer, such as LCP, PE, PTFE, fluoropolymer, or other plastic or insulating material(s), into the mold. The insulating material can flow around the terminal conductors 220-229 and 230-232 and the ground terminal conductors 240-249 within the mold, to form the inserts 250-254 at the locations shown in FIG. 2B.

The inserts 250-254 serve a number of purposes in the wafer assembly 200. The inserts 250-254 secure the terminal conductors 220-229 and 230-232 in place relative to each other. The inserts 250-254 also electrically isolate the terminal conductors 220-229 and 230-232 from each other. When formed, the insulating material of the inserts 250-254 can further flow through, or otherwise be inserted through, openings or apertures in the shields 270-277, and a heat staking process can be used to form staking caps of the inserts 250-254. The staking caps secure the inserts 250-254 with the shields 270-277. Thus, when formed, the inserts 250-254 secure the terminal conductors 220-229 and 230-232 into position with the ground terminal conductors 240-249, electrically isolate the terminal conductors 220-229 and 230-232 from each other, and electrically isolate the terminal conductors 220-229 and 230-232 from the ground terminal conductors 240-249.

The rigid shields 270-277 can be formed (e.g., stamped, sheared, bent, and otherwise formed) from a flat sheet of metal or other conductive material. In some cases, the sheet of metal can be plated with one or more plating metals. The flexible shields 280 and 281 can also be formed (e.g., stamped, sheared, or otherwise formed) from a flat sheet of metal or other conductive material, which can be plated in some cases.

The flexible shields 280 and 281 extend laterally across and contact subsets of the ground terminal conductors 240-249, at a position toward the tip ends of the ground terminal conductors of the ground terminal conductors 240-249, as best shown in the example of FIG. 2A. The flexible shield 280 spans across and is secured to each of the ground terminal conductors 240-244 in this example, and the flexible shield 281 spans across and is secured to each of the ground terminal conductors 245-249. Either or both of the flexible shields 280 and 281 can be located laterally across different subsets of the ground terminal conductors 240-249, at other locations or positions in some examples. A flexible shield that spans across and is coupled to different ground terminal conductors can help to electrically common potentials among such ground terminal conductors. The flexible shields 280 and 281 can be secured or otherwise attached across the ground terminal conductors 240-249 using adhesives, hot melting or welding, mechanical interferences or interlocking features, or using other means or approaches. The flexible shields 280 and 281 also form part of the shielding and grounding network in the connector 10. The flexible shields 280 and 281 are conductive and can electrically couple (i.e., electrically “common”) potentials among the ground terminal conductors 240-244 and 245-249, respectively.

Referring among FIGS. 2A and 2C, the wafer assembly 300 includes signal terminal conductors 320-329, 330, and 331 (also “signal terminals 320-329, 330, and 331”), among others, a power terminal conductor 332 (also “power terminal 332” and collectively “terminals 320-329 and 330-332”), ground terminal conductors 340-349, wafer molding inserts 350-354 (also “inserts 350-354”), rigid shields 370-377, and flexible shields 380 and 381. The wafer assembly 300 is illustrated as a representative example in FIG. 2A, and the size, number, shape, and other aspects of the components of the wafer assembly 300 can vary as compared to that shown.

The terminals 320-329 and 330-332 can be formed (e.g., stamped, sheared, bent, and otherwise formed) from a flat sheet of metal or other conductive material. In some cases, the sheet of metal can be plated with one or more plating metals. Each of the ground terminal conductors 340-349 can also be formed from the same flat sheet of metal or other conductive material, which can be plated in some cases.

The terminals 320-329 and 330-332 can be formed (e.g., stamped, sheared, bent, and otherwise formed) in a row, alongside each other, and at the same time from a single sheet of metal, in one example. Each of the terminals 320-329 and 330-332 includes a lead or tip contact at one distal end (i.e., positioned in the front port opening 12 of the connector 10, as shown in FIGS. 1A, 1D), a tail contact at another distal end (i.e., positioned at the terminal foot 13), and a terminal conductor body and bend between the tip contact and the tail contact. For example, as shown in FIG. 2C, the signal terminal conductor 328 includes a tip contact 328A and a tail contact 328B. The signal terminal conductor 329 also includes a tip contact 329A and a tail contact 329B. The tail contacts of the terminals 320-329 and 330-332 and the ground terminal conductors 340-349 can be formed as SMT tail contacts, as in the example shown, or as through-hole (e.g., eye-of-needle) or other types of tail contacts.

The signal terminal conductors 320-329, among others in the wafer assembly 300, can be arranged and used in pairs of terminal conductors to transfer high-speed differential signals. For example, the conductors 320 and 321 can be relied upon as a fourth pair of signal terminal conductors for communicating a fourth high-speed differential signal, the conductors 322 and 323 can be relied upon as a fifth pair of signal terminal conductors for communicating a fifth high-speed differential signal, the conductors 324 and 325 can be relied upon as a sixth pair of signal terminal conductors for communicating a sixth high-speed differential signal, and so on. The signal terminal conductors 330 and 331, among possibly others in the wafer assembly 300, can be relied upon as a pair of signal terminal conductors for communicating a second low-speed differential signal. The power terminal conductor 332 can be relied upon to source or sink power, for example, such as for sinking or sourcing a DC supply of power at 5V, 12V, or another potential.

The ground terminal conductors 340-349, the rigid shields 370-377, and the flexible shields 380 and 381 form part of a shielding and grounding network for the signal terminals 320-329, 330, and 331 in the wafer assembly 300 of the connector 10. The signal terminal conductors 320-329, 330, and 331, the power terminal conductor 332, the ground terminal conductors 340-349, and other terminal conductors of the wafer assembly 300 can be arranged with the rigid shields (e.g., 370-377 as shown in FIGS. 2A and 2C). The signal terminal conductors 320-329 extend along the channels of the rigid shields 370-377 in the wafer assembly 300. As shown in FIG. 2C, the pair of signal terminal conductors 320 and 321 can be positioned to extend along the channel of the rigid shield 370. In that arrangement, the rigid shield 370 provides EMI shielding for the signal terminal conductors 320 and 321 and helps to reduce crosstalk and spurious signals between the signal terminal conductors 320 and 321 and other terminal conductors in the connector 10. Similarly, the pair of signal terminal conductors 322 and 323 can be positioned to extend along the channel of the rigid shield 371, the pair of signal terminal conductors 324 and 325 can be positioned to extend along the channel of the rigid shield 374, and so on. In some examples, the wafer assembly 300 can include an additional rigid shield (not illustrated) that can be positioned at the middle of the wafer assembly 300 between the rigid shields 373 and 374. The signal terminal conductors 330 and 331 and the power terminal conductor 332 can be positioned to extend along the channel of such an additional shield, which can be similar to the rigid shields 370-377 and wider in these examples to accommodate the terminal conductors 330-332.

The inserts 350-354 can be formed by injection molding. In one example, the terminal conductors 320-329 and 330-332, among others in the row 310, can be arranged and positioned in a mold along with the ground terminal conductors 340-349. The inserts 350-354 can then be formed by the injection of a plastic or polymer, such as LCP, PE, PTFE, fluoropolymer, or other plastic or insulating material(s), into the mold. The insulating material can flow around the terminal conductors 320-329 and 330-332 and the ground terminal conductors 340-349 within the mold, to form the inserts 350-354 at the locations shown in FIG. 2C.

The inserts 350-354 serve a number of purposes in the wafer assembly 300. The inserts 350-354 secure the terminal conductors 320-329 and 330-332 in place relative to each other. The inserts 350-354 also electrically isolate the terminal conductors 320-329 and 330-332 from each other. When formed, the insulating material of the inserts 350-354 can further flow through, or otherwise be inserted through, openings or apertures in the shields 370-377, and a heat staking process can be used to form staking caps of the inserts 350-354. The staking caps secure the inserts 350-354 with the shields 370-377. Thus, when formed, the inserts 350-354 secure the terminal conductors 320-329 and 330-332 to the ground terminal conductors 340-349, electrically isolate the terminal conductors 320-329 and 330-332 from each other, and electrically isolate the terminal conductors 320-329 and 330-332 from the ground terminal conductors 340-349.

The rigid shields 370-377 can be formed (e.g., stamped, sheared, bent, and otherwise formed) from a flat sheet of metal or other conductive material. In some cases, the sheet of metal can be plated with one or more plating metals. The flexible shields 380 and 381 can also be formed from a flat sheet of metal or other conductive material, which can be plated in some cases.

The flexible shields 380 and 381 extend laterally across and contact subsets of the ground terminal conductors 340-349, at a position toward the tip ends of the ground terminal conductors of the ground terminal conductors 340-349, as best shown in the example of FIG. 2A. The flexible shield 380 spans across and is secured to each of the ground terminal conductors 340-344 in this example, and the flexible shield 381 spans across and is secured to each of the ground terminal conductors 345-349. Either or both of the flexible shields 380 and 381 can be located laterally across different subsets of the ground terminal conductors 340-349 compared to those shown, at other locations or positions in some examples. A flexible shield that spans across and is coupled to different ground terminal conductors can help to electrically common potentials among such ground terminal conductors. The flexible shields 380 and 381 can be secured or otherwise attached across the ground terminal conductors 340-349 using adhesives, hot melting or welding, mechanical interferences or interlocking features, or using other means or approaches. The flexible shields 380 and 381 also form part of the shielding and grounding network in the connector 10. The flexible shields 380 and 381 are conductive and can electrically couple (i.e., electrically “common”) potentials among the ground terminal conductors 340-344 and 345-349, respectively.

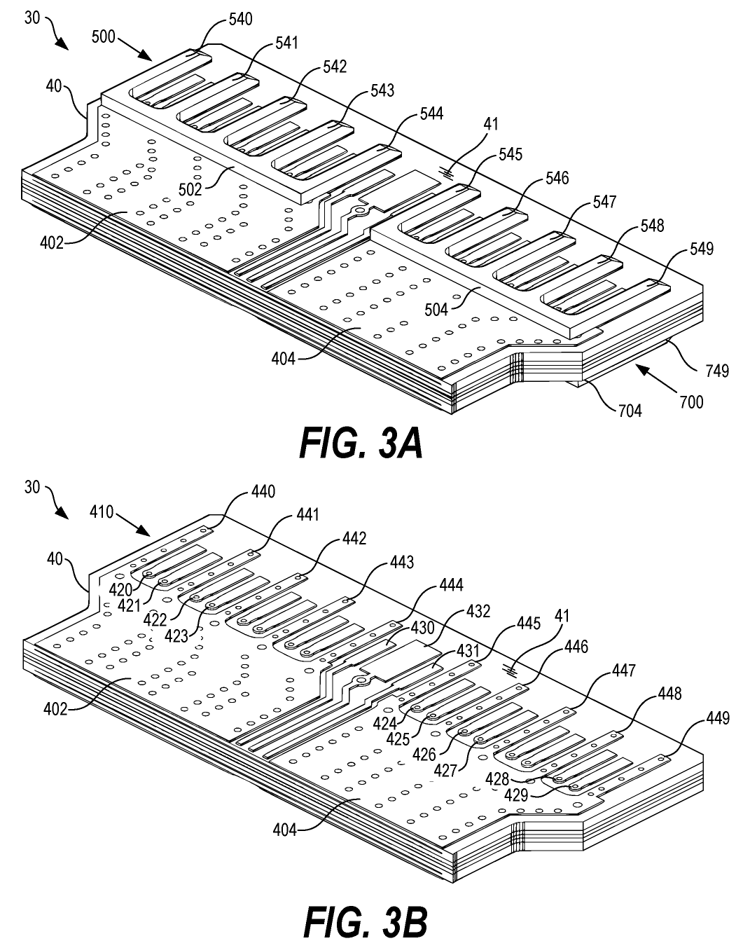

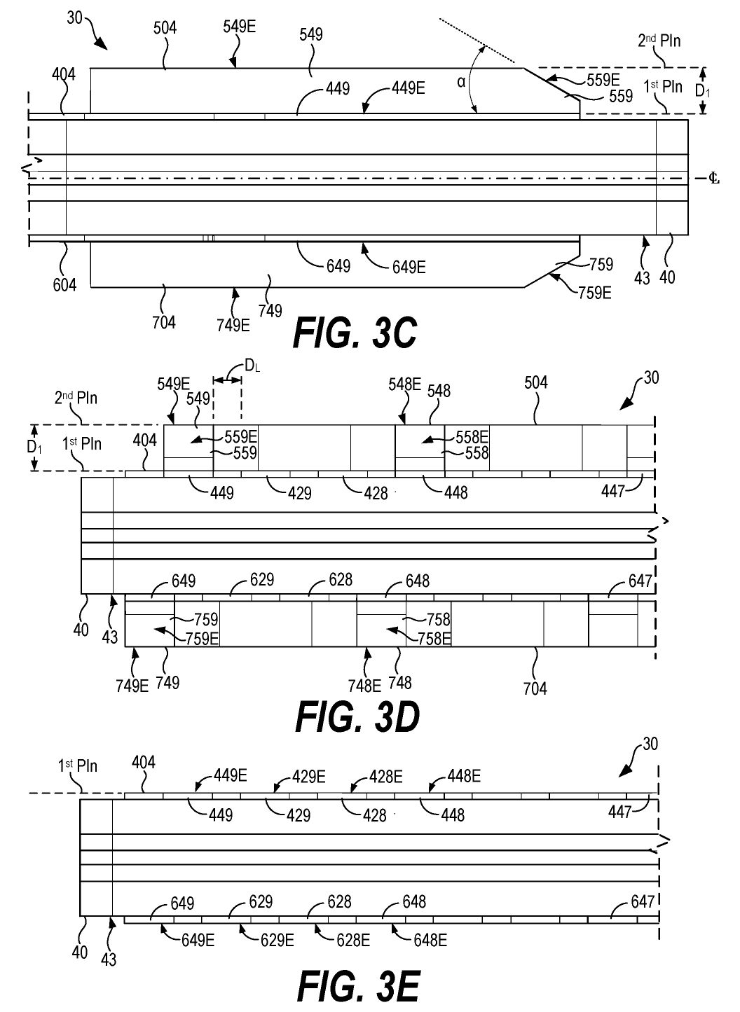

FIGS. 3A-3E illustrate different views of the board card edge interface 30 shown in FIGS. 1C and 1D according to various aspects and embodiments of the present disclosure. FIG. 3A illustrates a top-down perspective view of the board card edge interface 30 as shown in FIG. 1C, and FIG. 3B illustrates another top-down perspective view of the board card edge interface 30 with certain components removed from view. FIGS. 3C and 3D illustrate a side view and a front view, respectively, of the board card edge interface 30 as shown in FIG. 1C. FIG. 3E illustrates another front view of the board card edge interface 30 with the ground shields 504 and 704 removed from view according to various aspects and embodiments of the present disclosure.

The board card edge interface 30 is an example of a board card edge interface (also “card edge interface”) that can be used with various connectors such as the connector 10 in some cases. For instance, the board card edge interface 30 is illustrated as a representative example of a PCB-style tip of an SFP module. The board card edge interface 30 is illustrated as a representative example of a board card edge interface including ground and signal pad contacts with contact pad surfaces positioned in different contact planes. The concepts described herein can be extended to use with a range of board card edge interfaces and connectors of different types, styles, and formats, however. The board card edge interface 30 is not drawn to any particular scale or size in the drawings. The shape, size, proportion, and other characteristics of the board card edge interface 30 can vary as compared to that shown. For example, the board card edge interface 30 can accommodate larger or smaller rows of terminal contacts (e.g., be wider or narrower), and other variations are within the scope of the examples described herein. A number of board card edge interfaces similar to the board card edge interface 30 can be used in combination with a number of connectors that can be stacked or arranged side-by-side, for higher data rate interconnection systems. Additionally, one or more of the parts or components of the board card edge interface 30, as illustrated in the drawings and described herein, can be omitted in some cases. The board card edge interface 30 can also include other parts or components that are not illustrated.

Referring among FIGS. 3A-3E, the board card edge interface 30 includes a substrate 40 having one or more ground, signal, and power pads or planes formed at least partly on or integrated into one or more surfaces of the substrate 40, among other features. The board card edge interface 30 in this example includes conductive ground pads or planes 402 and 404 (also “ground planes 402 and 404”) formed on or over a top surface 41 of the substrate 40. The board card edge interface 30 also includes similar conductive ground pads or planes formed on or over a bottom surface 43 of the substrate 40 such as the conductive ground pad or plane 604 (also “ground plane 604”) seen in FIG. 3C.

The board card edge interface 30 further includes a row 410 of terminal contacts (see FIG. 3B) formed on the top surface 41 of the substrate 40, and a similar row of contact pads formed on the bottom surface 43 of the substrate 40. The rows of terminal contacts can include one or more conductive signal, ground, and power contact pads formed at least partly on or integrated into the top surface 41 and the bottom surface 43, respectively, of the substrate 40.

The row 410 of terminal contacts includes conductive signal contact pads 420-429, 430, and 431 (also “signal pads 420-429, 430, and 431”), a conductive power contact pad 432 (also “power pad 432”) and conductive ground contact pads 440-449 (also “ground pads 440-449”) formed on the top surface 41 of the substrate 40 in the example shown. Each of the signal pads 420-429, 430, 431, the power pad 432, and the ground pads 440-449 in this example has an exposed contact pad surface, such as the exposed contact pad surfaces 428E and 429E (also “pad surfaces 428E and 429E”) of the signal pads 428 and 429 and the exposed contact pad surfaces 448E and 449E (also “pad surfaces 448E and 449E”) of the ground pads 448 and 449, as shown in FIG. 3E. Similar to the row 410, the substrate 40 also includes a row of conductive signal, power, and ground contact pads formed on the bottom surface 43 of the substrate 40 in this example, such as the conductive signal contact pads 628 and 629 (also “signal pads 628 and 629”) and the conductive ground contact pads 648 and 649 (also “ground pads 648 and 649”), as shown in FIG. 3E. Each of the signal, power, and ground contact pads on the bottom surface 43 has an exposed contact pad surface, such as the exposed contact pad surfaces 628E and 629E (also “pad surfaces 628E and 629E”) of the signal pads 628 and 629 and the exposed contact pad surfaces 648E and 649E (also “pad surfaces 648E and 649E”) of the ground pads 648 and 649, as shown in FIG. 3E.

The ground plane 402 and terminal pad contacts in the row 410 of terminal contacts (e.g., the signal pads 420-423, the ground pads 440-444) can be embodied as separated pads or regions of a metal layer formed over the top surface 41 of the board card edge interface 30, which is a PCB. The ground plane 404 and terminal pad contacts in the row 410 of terminal contacts (e.g., the signal pads 424-429, the ground pads 445-449) can be embodied as separated pads or regions of a metal layer formed over the top surface 41 of the board card edge interface 30. Similarly, the substrate 40 also includes a ground plane 604 and terminal pad contacts in a row of terminal contacts (e.g., the signal pads 628 and 629, the ground pads 648 and 649) formed over the bottom surface 43 of the board card edge interface 30.

The board card edge interface 30 can also include one or more ground or riser shields 500 and 700 formed on or otherwise coupled to one or more of the ground planes or ground pads on at least one of the top surface 41 or the bottom surface 43 of the substrate 40. In the example shown, the board card edge interface 30 includes a ground shield 502 coupled to the ground pads 440-444 formed on the top surface 41 of the substrate 40 and a ground shield 504 coupled to the ground pads 445-449, which are also formed on the top surface 41 of the substrate 40. The board card edge interface 30 further includes a ground shield 704 on one or more ground pads formed on the bottom surface 43 of the substrate 40 such as the ground pads 648 and 649 seen in FIGS. 3D and 3E in this example.

Each of the ground shields 500 and 700 on the board card edge interface 30 is embodied as and includes a plurality of U-shaped shield pockets (see FIGS. 3A, 3D, and 3E), although another geometry may be relied on in other cases. The U-shaped shield pockets are at least partly defined by and embodied as a collection of individual ground shield pad contacts formed on or otherwise coupled to corresponding ground pads on the substrate 40. In the example shown, the ground shield 502 includes ground shield pad contacts 540-544 (also “shield pads 540-544”) formed on the top of the ground shield 502, and the ground shield 504 includes ground shield pad contacts 545-549 (also “shield pads 545-549”), which are also formed on the top of the ground shield 504. Similarly, the ground shields 700 include ground shield pad contacts formed on the bottom of the ground shields 700, such as the ground shield pad contacts 748 and 749 (also “shield pads 748 and 749”) seen in FIGS. 3A, and 3D in this example.

In some cases, one or more of the ground shields 500 and 700 can be embodied as and include an individual ground shield pad contact strip or a collection of individual ground shield pad contact strips formed on or otherwise coupled to corresponding ground pads on the substrate 40. One or more of the U-shaped regions of one or more of the ground shields 500 and 700 may be omitted in some cases. For example, at least one of the shield pads 540-544 on the ground shield 502 may be embodied as an individual ground shield pad contact strip formed on at least one corresponding ground pad 440-444.

The ground shield pad contacts of the ground shields 500 and 700 include one or more exposed contact pad surfaces that can at least partly interface with, guide, and support one or more corresponding tip contacts of the ground terminal conductors in the rows 210 and 310 of terminal conductors in the connector 10 when the board card edge interface 30 is inserted in the front opening 12 of the connector 10. Each of the shield pads 540-549 in the example shown has an exposed contact pad surface, such as the exposed contact pad surfaces 548E and 549E (also “contact pad surfaces 548E and 549E”) of the shield pads 548 and 549 shown in FIGS. 3C and 3D.

The pad surfaces of the signal and ground pads in the rows of terminal contacts on the substrate 40 are positioned in a different contact plane relative to the pad surfaces on the ground shields 500 and 700. For instance, as shown in FIGS. 3C-3E, the pad surfaces 428E and 429E of the signal pads 428 and 429 and the pad surfaces 448E and 449E of the ground pads 448 and 449 are positioned in a first contact plane (“1^{st} Pln”), whereas the pad surfaces 548E and 549E of the shield pads 548 and 549 are positioned in a second contact plane (“2^{nd} Pln”) that is different from the first contact plane. The pad surfaces of the signal and ground pads in the rows of terminal contacts on the substrate 40 are also offset from a longitudinal centerline (℄) of the board card edge interface 30 relative to the pad surfaces on the ground shields 500 and 700. For example, the pad surfaces 428E and 429E of the signal pads 428 and 429 and the pad surfaces 448E and 449E of the ground pads 448 and 449 are positioned a first offset distance from the longitudinal centerline ℄ of the board card edge interface 30 and the pad surfaces 548E and 549E of the shield pads 548 and 549 are positioned a second offset distance from the longitudinal centerline ℄ of the board card edge interface 30. The longitudinal centerline ℄ of the board card edge interface 30 aligns with the longitudinal centerline ℄ of the front opening 12 of the connector 10 when the board card edge interface 30 is inserted into the opening 12.

The ground shields 500 and 700 can also include ground shield terminal ramps formed at one side. For instance, the ground shield terminal ramps may be formed at one side of each of the ground shields 500 and 700 in some cases. The ground shield terminal ramps may also be formed at and along a side or an edge of the board card edge interface 30 in other examples. For instance, the ground shield terminal ramps may be formed at and along a front edge of the board card edge interface 30 that faces the opening 12 of the connector 10 when the board card edge interface 30 is inserted into the connector 10. In at least one example, each of the ground shields 500 and 700 includes a ground shield terminal ramp that is formed at one side of the ground shield and at a front edge of the board card edge interface 30 that faces the opening 12 of the connector 10 when the board card edge interface 30 is inserted into the connector 10.

The ground shield terminal ramps each include an exposed contact pad ramp surface that can be configured to interface with a corresponding tip contact of a ground terminal conductor in the rows 210 and 310 of terminal conductors in the connector 10 when the board card edge interface 30 is inserted into the front opening 12 of the connector 10. Each of the shield pads 540-549 in the example shown has a ground shield terminal ramp formed at one end with an inclined and exposed contact pad surface such as the inclined surfaces 558E and 559E of the shield pad ramps 558 and 559 shown in FIGS. 3C and 3D. The ground shield terminal ramps are each inclined at an inclined angle (α) that can be defined relative to the above-described first contact plane in which the pad surfaces 428E and 429E of the signal pads 428 and 429 and the pad surfaces 448E and 449E of the ground pads 448 and 449 are positioned as shown in FIGS. 3C-3E.

The shield pad ramps on the ground shields 500 and 700 can be configured to at least partly wipe or otherwise interface with, support, and guide corresponding tip contacts of ground terminal conductors in the rows 210 and 310 of terminal conductors in the connector 10 when the board card edge interface 30 is inserted into the front opening 12 of the connector 10. For instance, the shield pad ramps on the ground shields 500 and 700 can be configured to at least partly wipe or otherwise interface with, support, and guide such corresponding tip contacts to the second contact plane (2^{nd} Pln) where the tip contacts can rest upon the exposed contact pad surfaces of the ground shields 500 and 700 when the board card edge interface 30 is inserted into the front opening 12 of the connector 10.

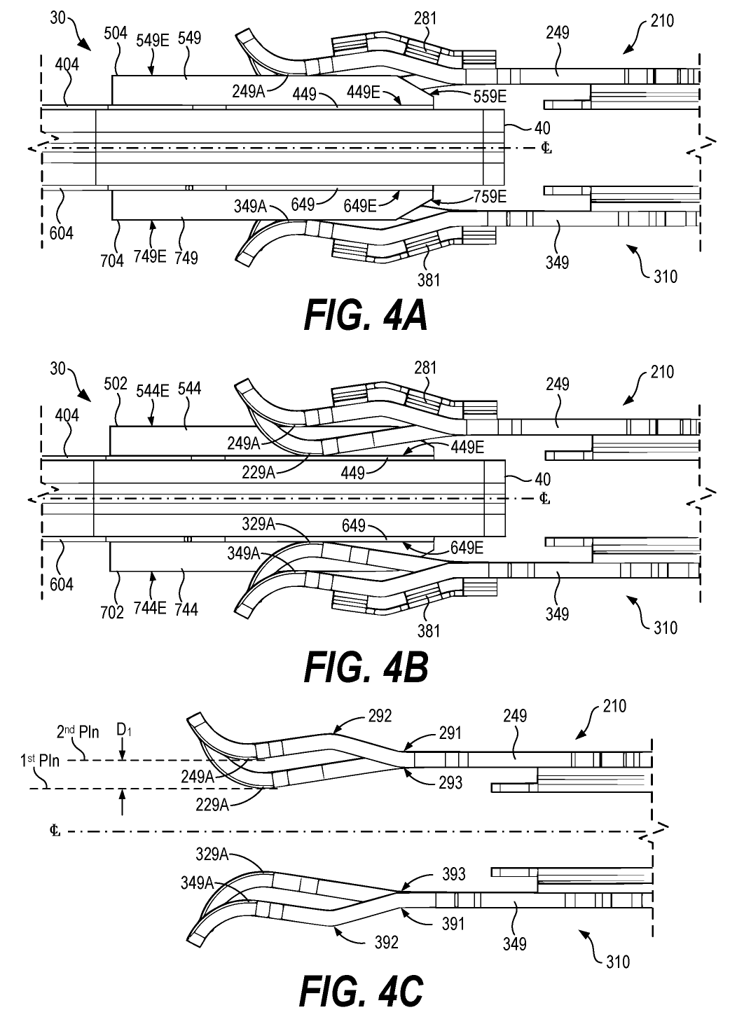

As illustrated in FIGS. 3A, 3D, 4A, and 4D, and described further herein, the inclined surfaces 558E and 559E of the shield pad ramps 558 and 559 are configured to interface with, support, and guide the tip contacts 248A and 249A of the ground terminal conductors 248 and 249 in the row 210 of terminal conductors in the connector 10 when the board card edge interface 30 is inserted into the front opening 12 of the connector 10. For instance, the inclined surfaces 558E and 559E of the shield pad ramps 558 and 559 are configured to interface with, support, and guide the tip contacts 248A and 249A to the second contact plane (2^{nd} Pln) where these tip contacts can rest upon the contact pad surfaces 548E and 549E of the shield pads 548 and 549, respectively, when the board card edge interface 30 is inserted into the front opening 12 of the connector 10. Also, the inclined surfaces 758E and 759E of the shield pad ramps 758 and 759 are configured to interface with, support, and guide the tip contacts 348A and 349A of the ground terminal conductors 348 and 349 in the row 310 of terminal conductors in the connector 10 when the board card edge interface 30 is inserted into the front opening 12 of the connector 10. For instance, the inclined surfaces 758E and 759E of the shield pad ramps 758 and 759 are configured to interface with, support, and guide the tip contacts 348A and 349A to rest upon the contact pad surfaces 748E and 749E of the shield pads 748 and 749, respectively, when the board card edge interface 30 is inserted into the front opening 12 of the connector 10. The ground shields 500 and 700 and in particular the shield pads of the ground shields such as the shield pads 540-549 provide robust shielding walls and EMI rejection between pairs of signal terminal conductors in the connector 10.

As illustrated in FIGS. 3D and 4C, the ground shields 500 and 700 can be embodied as or include a riser shield that extends a distance (“D₁”) over at least a subset of the ground pad contacts formed on the substrate 40. The distance D₁ can be set based on a lateral distance (“D_{L}”) between sides of a ground pad contact and a signal pad contact formed on the substrate 40 in some examples. The distance D₁ can be at least three times greater than such a lateral distance D_{L} in one example. In another example, the distance D₁ can be up to five times greater than such a lateral distance D_{L}. In one example, the lateral distance D_{L} can extend from a side edge of the signal pad 429 to a side edge of the ground pad 449 as illustrated in FIG. 3D.

Any or all of the ground shields 500 and 700 can be embodied with and include at least one of copper, a copper alloy, aluminum, an aluminum alloy, another electrically conductive material or alloy, or any combination thereof. The ground shields 500 and 700 can be coupled to the board card edge interface 30 using a conductive adhesive, compliant pins, or solder. For instance, the ground shield 502 or at least one or more of the shield pads 540-544 can be coupled to corresponding ground pads 440-444 and ground plane 402 on the board card edge interface 30 using a conductive adhesive or solder.

FIGS. 4A-4C illustrate different side views of the board card edge interface 30 and the rows 210 and 310 of terminal conductors in the connector 10 according to various aspects and embodiments of the present disclosure. FIG. 4A illustrates a side view of the board card edge interface 30 inserted into the connector 10 as shown in FIGS. 1C and 1D. FIG. 4B illustrates another side view of the board card edge interface 30 inserted into the connector 10 with the ground shields 504 and 704 on the board card edge interface 30 removed from view. FIG. 4C illustrates a side view of the rows 210 and 310 of terminal conductors in the connector 10 according to various aspects and embodiments of the present disclosure.

FIGS. 4A-4C illustrate an example of how certain signal and ground terminals in the connector 10 at least partly wipe or otherwise interface with certain signal pads and ground shield pads on the board card edge interface 30 when the board card edge interface 30 is inserted in the front opening 12 of the connector 10. As illustrated in FIG. 4C, the ground terminal conductor 249 can include a first bend 291 that angles the contact tip surface 249A of the ground terminal conductor 249 away from both the longitudinal centerline ℄ of the front opening 12 of the connector 10 and the longitudinal centerline ℄ of the board card edge interface 30, which are aligned with one another when the board card edge interface 30 is inserted into the opening 12. The ground terminal conductor 249 can also include a second bend 292 that angles the contact tip surface 249A of the ground terminal conductor 249 toward the longitudinal centerline ℄ of each of the opening 12 and the board card edge interface 30. The first bend 291 and the second bend 292 can collectively position the contact tip surface 249A of the ground terminal conductor 249 at a different distance (e.g., a farther distance) from such a shared longitudinal centerline ℄ relative to the contact tip surface 229A of the signal terminal conductor 229 as shown in FIG. 4C. In some examples, the first bend 291 and the second bend 292 can collectively position the contact tip surface 249A of the ground terminal conductor 249 at a distance from the contact tip surface 229A of the signal terminal conductor 229 that is approximately equal to the previously described distance D₁ as shown in FIG. 4C.

The first bend 291 can be located farther from the contact tip surface 249A of the ground terminal conductor 249 relative to the second bend 292 in many cases. In some cases, the first bend 291 may have a bend angle magnitude that is approximately equal to that of the second bend 292 relative to the longitudinal centerline ℄ of the opening 12 of the connector 10 and the board card edge interface 30. For instance, the first bend 291 and the second bend 292 may have bend angles of approximately 15° and -15°, respectively, relative to the longitudinal centerline ℄ of the opening 12 of the connector 10 and the board card edge interface 30 in some cases. Other bend angles for the first bend 291 and the second bend 292 may be relied upon in other cases. In some examples, the first bend 291 may have a bend angle magnitude that is less than that of the second bend 292 relative to the longitudinal centerline ℄ of the opening 12 and the board card edge interface 30. In still other examples, the first bend 291 may have a bend angle magnitude that is greater than that of the second bend 292 relative to the longitudinal centerlines ℄ of the opening 12 and the board card edge interface 30.

As shown in FIG. 4C, the first bend 291 projects a first segment of the ground terminal conductor 249 away from the longitudinal centerline ℄ of the opening 12 of the connector 10 and the board card edge interface 30 and the second bend 292 projects a second segment of the ground terminal conductor 249 toward the longitudinal centerline ℄. The signal terminal conductor 229 also includes a bend 293 that projects a segment of the signal terminal conductor 229 toward the longitudinal centerline ℄ of the opening 12 and the board card edge interface 30. This segment of the signal terminal conductor 229 can be approximately parallel to and offset from the second segment of the ground terminal conductor 249 relative to the longitudinal centerline ℄ of the opening 12 and the board card edge interface 30 in some cases. In other examples, such a segment of the signal terminal conductor 229 may not be parallel to the second segment of the ground terminal conductor 249 relative to the longitudinal centerline ℄ of the opening 12 and the board card edge interface 30.

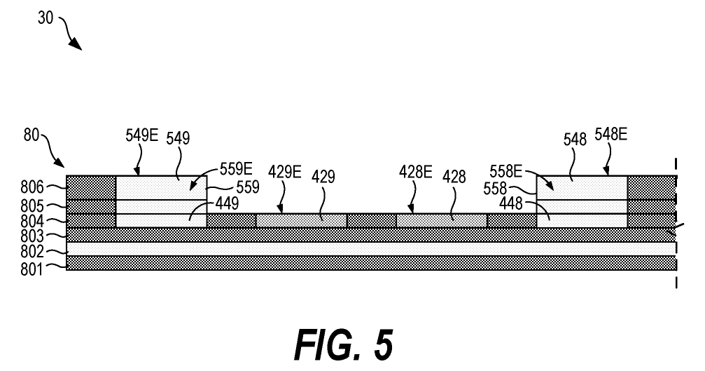

FIG. 5 illustrates a front view of another example substrate 80 of the board card edge interface 30 shown in FIG. 3A according to various aspects and embodiments of the present disclosure. The substrate 80 is an example alternative embodiment of the substrate 40 with ground or riser shields 500 and 700 described herein with reference to FIGS. 3A-3E.

In the example shown in FIG. 5, the substrate 80 includes a plurality of individual or discrete layers 801-806 (also “layers 801-806”), the signal pads 428 and 429, the ground pads 448 and 449, and the shield pads 548 and 549, among other features. Individual ones of the layers 801 and 803-806 can be embodied as or include at least one of an insulating material, a dielectric material, or another material. Layer 802 of the substrate 80 can be embodied as or include a conductive ground layer, plane, or pad such as the ground plane 404 of the substrate 40. The signal pads 428-429 and the ground pads 448 and 449 are each formed on the layer 803 of the substrate 80 and positioned in the layer 804 in the example shown. The shield pads 548 and 549 are formed on the ground pads 448 and 449, respectively, which are positioned in the layer 804 and the shield pads 548 and 549 themselves are positioned in and across the layers 805 and 806 of the substrate 80 in this example.

As illustrated in FIG. 5, the layers 804 and 805 are positioned in the substrate 40 between the layers 803 and 806 in this example. Additionally, the pad surfaces 428E and 429E of the signal pads 428 and 429 and the contact pad surfaces 548E and 549E of the shield pads 548 and 549 are positioned in different contact planes as shown.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A connector, comprising:
a housing comprising a slot for insertion of a card edge interface; and
a row of terminal conductors positioned within the housing, the row of terminal conductors comprising ground terminal conductors and signal terminal conductors, wherein:
contact tip surfaces of the ground terminal conductors are positioned in a different plane than contact tip surfaces of the signal terminal conductors.

2. The connector of claim 1, wherein:
the contact tip surfaces of the signal terminal conductors are positioned in a first plane;
the contact tip surfaces of the ground terminal conductors are positioned in a second plane; and
the second plane is offset from a longitudinal centerline of the slot of the housing relative to the first plane.

3. The connector of claim 1, wherein:
the contact tip surfaces of the signal terminal conductors are configured to contact signal contact pads on the card edge interface in a first contact plane when the card edge interface is inserted into the slot of the housing;
the contact tip surfaces of the ground terminal conductors are configured to contact a ground shield on the card edge interface in a second contact plane when the card edge interface is inserted into the slot of the housing; and
the second contact plane is offset from a longitudinal centerline of the slot of the housing relative to the first contact plane.

4. The connector of claim 1, wherein:
the ground terminal conductors comprise first bends that angles the contact tip surfaces of the ground terminal conductors away from a longitudinal centerline of the slot of the housing and second bends that angles the contact tip surfaces of the ground terminal conductors toward the longitudinal centerline of the slot; and
the first bends and the second bends collectively position the contact tip surfaces of the ground terminal conductors at a different distance from the longitudinal centerline of the slot relative to the contact tip surfaces of the signal terminal conductors.

5. The connector of claim 4, wherein the first bends have a bend angle that is equal to a bend angle of the second bends relative to the longitudinal centerline of the slot.

6. The connector of claim 4, wherein:
the first bends are located farther from the contact tip surfaces of the ground terminal conductors relative to the second bends; and
the first bends have a bend angle that is less than a bend angle of the second bends relative to the longitudinal centerline of the slot.

7. The connector of claim 4, wherein:
the first bends are located farther from the contact tip surfaces of the ground terminal conductors relative to the second bends; and
the first bends have a bend angle that is greater than a bend angle of the second bends relative to the longitudinal centerline of the slot.

8. The connector of claim 4, wherein:
the first bends project first segments of the ground terminal conductors away from the longitudinal centerline of the slot and the second bends project second segments of the ground terminal conductors toward the longitudinal centerline of the slot;
the signal terminal conductors comprise bends that project segments of the signal terminal conductors toward the longitudinal centerline of the slot; and
the segments of the signal terminal conductors are parallel to and offset from the second segments of the ground terminal conductors relative to the longitudinal centerline of the slot.

9. A card edge interface for use in a connector, the card edge interface comprising:
a substrate;
a row of terminal contacts on the substrate, the row of terminal contacts comprising signal pad contacts and ground pad contacts; and
a ground shield on at least a subset of the ground pad contacts, wherein:
contact pad surfaces for the signal pad contacts are positioned in a first contact plane; and
a contact pad surface for the ground shield is positioned in a second contact plane.

10. The card edge interface of claim 9, wherein the ground shield comprises at least one ground terminal ramp at one side, the at least one ground terminal ramp extending at an inclined angle relative to the first contact plane.

11. The card edge interface of claim 10, wherein the ground shield comprises a plurality of U-shaped shield pockets.

12. The card edge interface of claim 10, wherein an upper surface of the ground shield comprises the contact pad surfaces for the ground pad contacts.

13. The card edge interface of claim 10, wherein the ground shield comprises a riser shield that extends a distance over at least a subset of the ground pad contacts.

14. The card edge interface of claim 13, wherein the distance is set based on a lateral distance between a signal pad contact among the signal pad contacts and a ground pad contact among the ground pad contacts.

15. The card edge interface of claim 14, wherein the distance is at least three times greater than the lateral distance.

16. The card edge interface of claim 14, wherein the distance is up to five times greater than the lateral distance.

17. The card edge interface of claim 10, wherein the ground shield comprises at least one of copper, a copper alloy, aluminum, or an aluminum alloy.

18. The card edge interface of claim 10, wherein the ground shield is coupled to at least a subset of the ground pad contacts using a conductive adhesive or solder.

19. The card edge interface of claim 9, wherein:
the ground pad contacts are formed on a first layer of the substate; and
the signal pad contacts are formed on a second layer of the substate different from the first layer of the substate.

20. The card edge interface of claim 9, wherein:
the substrate comprises a plurality of layers;
the ground pad contacts are formed on a first layer of the substate;
the signal pad contacts are formed on a second layer of the substate different from the first layer of the substate; and
the substrate comprises at least one additional layer between the first layer and the second layer.
